(19) United States
(12) Patent Application Publication
(10) Pub. No.: US 2010/0031469 A1
(43) Pub. Date: Feb. 11, 2010

(54) Damped Closing Mechanism for automatic Shutting Pull Door

(76) Inventor: Chou-Chih CHIANG, Taichung City (TW)

Correspondence Address: HDLS Patent & Trademark Services, P.O. BOX 220746, CHANTILLY, VA, 20153-0746, US

(21) Appl. No.: 12/187,551

(22) Filed: Aug. 7, 2008

(51) Int. Cl. E05F 3/18; E05F 3/00

(52) U.S. Cl. 16/64; 16/49

(57) ABSTRACT

In a damped closing mechanism for automatic shutting pull door, a door closing mechanism includes a screw wheel to store restoring force, a change over device and a brake gear to produce a damping effect is integrally combined and equipped on the frame of a moving door panel. The brake gear is to alleviate the actuating force and moving speed of the door panel provided by the screw wheel. The change over device is capable of changing the damping effect of the brake gear to generate nearby the closing position of the door so as to alleviate colliding speed and impulse of the moving door panel with the door post when shutting without affecting the pulling of the door panel before closing.

### BACKGROUND OF THE INVENTION

1. Field of the Invention

The present invention relates to the scientific technology of automatic shutting pull door, and in particular, to a damped closing mechanism for automatic shutting pull door in which the automatic closing mechanism can perform a varied damping effect to alleviate the closing force and retard the travelling speed when the moving door panel is about to reach the final shut position so as to avoid the door panel to collide with the door post too forcibly that might result in damaging the door.

2. Description of the Prior Art

For the purpose of performing closing and opening operation of the door efficiently and silently, an automatic door closing mechanism is employed. For example, in order to avoid too loud bumping noise and accidental disruption of a door when closing it too forcibly, an automatic closing mechanism is provided for a revolving or a pull door to alleviate the closing impulse or retard closing speed. As for a pull door in which the door panel makes transverse displacement, there have been disclosed many kinds of automatic closing mechanism with a variety of functions, namely, “Speed Governor for Automatically Shutting Pull Door” (Taiwan Pat. No. 445340), “Locking Device of Pull Door” (Taiwan Pat. No. 1295335), and “Automatic Closing Device for Pull Door” (Taiwan Pat. No. 200743717) etc.

Take the last one for example, it has successfully eliminated the prior flaw of employing a bulky and awkward rack rail in its automatic closing device, however, it has not been liberated form the conventional disadvantage of lacking damping effect of the helical spring in the closing device that results in failing to lower the travelling speed of the door panel, and causing a loud bumping noise or even disruption of the mechanism or door itself when the door is closed.

In view of the foregoing situation, the inventor of the present invention herein has gone to great length of intensive research based on many years of experience gained through professional engagement in the manufacturing of the related products, with continuous experimentation and improvement culminating in the development of the present invention.

### SUMMARY OF THE INVENTION

Accordingly, the object of the present invention is to provide a damped closing mechanism for automatic shutting pull door having a change over device capable of changing the damping effect generated nearby the closing position of the door so as to alleviate colliding speed and impulse of the moving door panel with the door post when shutting without affecting pulling of the door panel before closing.

To achieve the afore said object, the gist of the present invention is to provide a damped closing mechanism essentially comprising a base, a screw wheel, a change over device and a brake gear.

The screw wheel is erected on the base and having a coil spring to produce a restoring resilient force. The screw wheel is able to wind back and stretch out a rope whose exposed end is fasten to a door panel or door frame where the damped closing mechanism being not installed so as to stretch out the rope when the door panel is away form the shut position; and when liberating the door panel, the screw wheel winds back the rope to move the door panel to approach the shut position.

The change over device is erected on the base and having a first and a second rocking bars radially extended with an angle therebetween. The size of opened angle depends on the predetermined retarding distance for the screw wheel to go. There is a brake member provided at the nearby door closing position on the door frame or door panel to where the exposed end of the rope is fastened for stirring up the first and the second rocking bars.

The brake gear erected on the base revolves simultaneously with the screw wheel. There is a damping element contained in the brake gear to provide a damping effect. Corresponding with the first and second rocking bars, there are a first and a second positioning dents formed on the brake gear, and a corresponding ball button is provided on the sidewall of the base for the change over device to vary the damping effect of the brake gear.

With this scheme, when the door panel approaches the door closing position, the change over device actuates the brake gear to vary its position to begin damping so as to alleviate the colliding force and speed of the door panel with the door post yet without affecting pulling back of the door panel before closing.

### BRIEF DESCRIPTION OF THE DRAWINGS

Other objects and purposes of the invention will be apparent to persons acquainted with apparatus of this general type upon reading the following specification and inspection of the accompanying drawings.

FIG. 1 is a perspective view of the present invention.

FIG. 2 is a perspective view showing the component arts inside of the closing mechanism according to the present invention.

FIG. 3 is a rear view of FIG. 2.

FIG. 4 through FIG. 6 are schematic views respectively showing the location of the closing mechanism when the door is closed, starting to close and approaching closed position.

FIG. 7 is a schematic view the door is shut whereas the closing mechanism is installed at other side of the door panel.

FIG. 8 is a schematic view after operation whereas the closing mechanism is installed at the other side opposite to that of FIG. 7.

FIG. 9 through FIG. 11 are illustrative views respectively showing the component parts of the closing mechanism before, at and after operation.

FIG. 12 is a schematic view of the change over device in second embodiment of the present invention.

FIG. 13 and FIG. 14 are three-dimensional views showing respectively the state of closing mechanism before and after operation.

### DETAILED DESCRIPTION OF THE PREFERRED EMBODIMENT

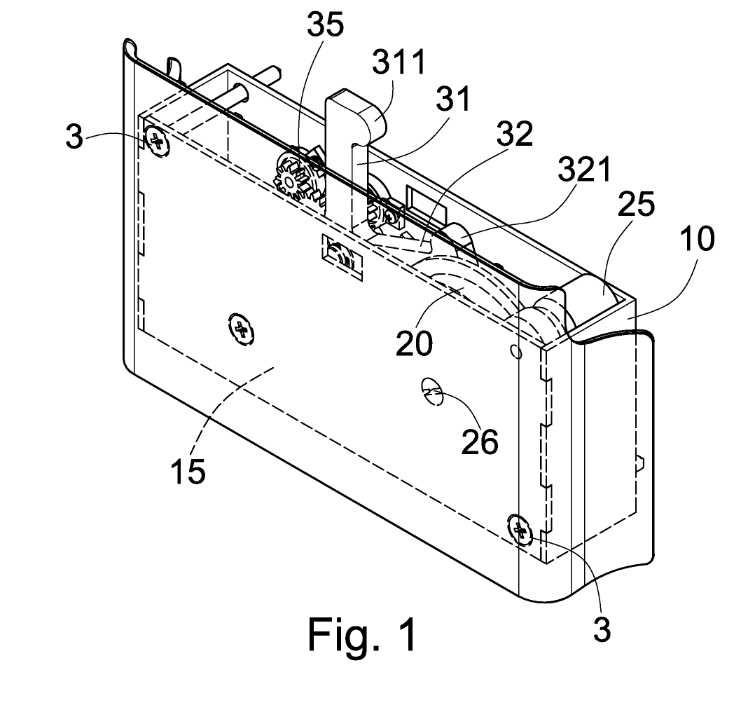

Referring to FIG. 1 through FIG. 3, the damped closing mechanism for automatic shutting pull door of the present invention comprises a base 10, a screw wheel 20, a change over device 30, a brake gear 40 and a rope 50.

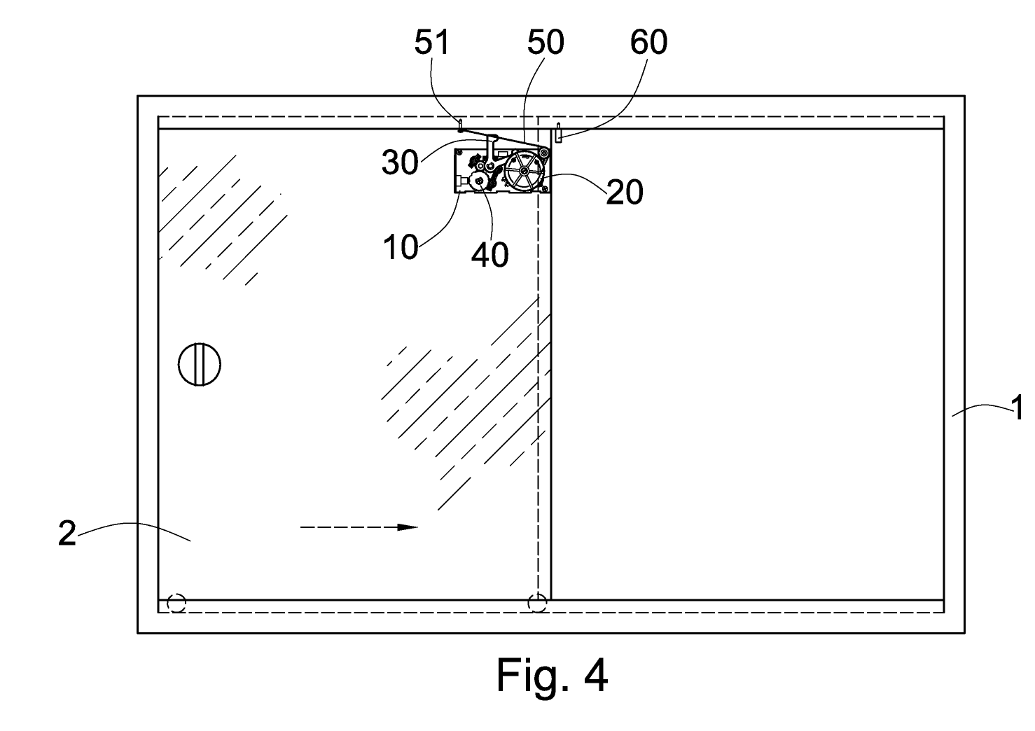

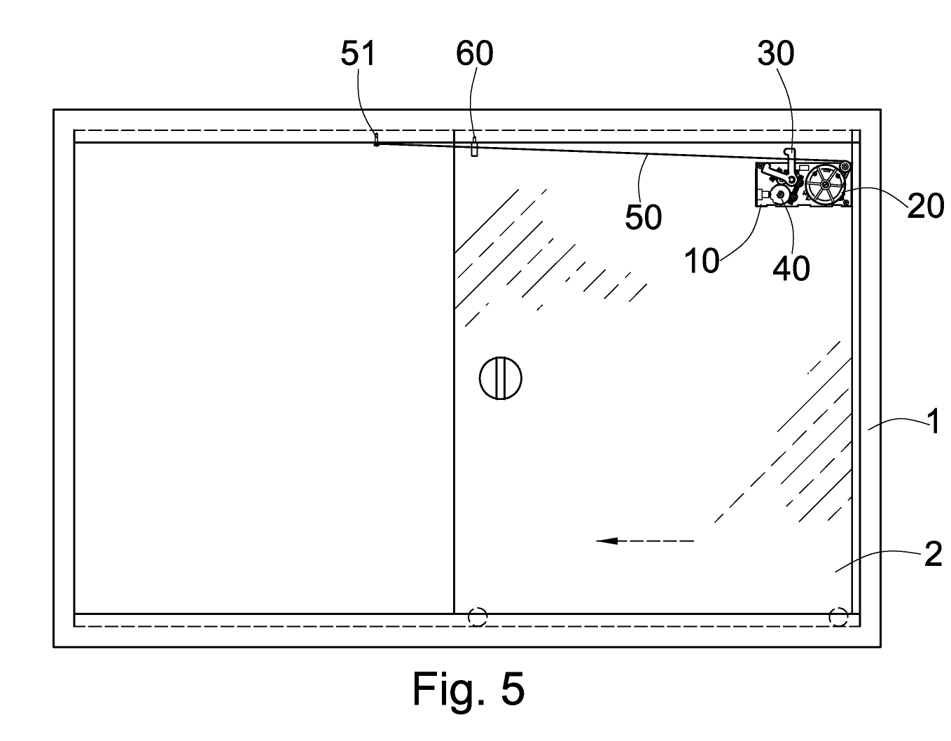

Referring further to FIG. 4 through FIG. 6 for understanding more detailed scheme, wherein the base 10 is a [symbol] shaped frame member having a fence 15 to enclose the bottom and side opening around the base 10 such that an upwardly opened accommodation space is formed between the base 10 and the fence 15.

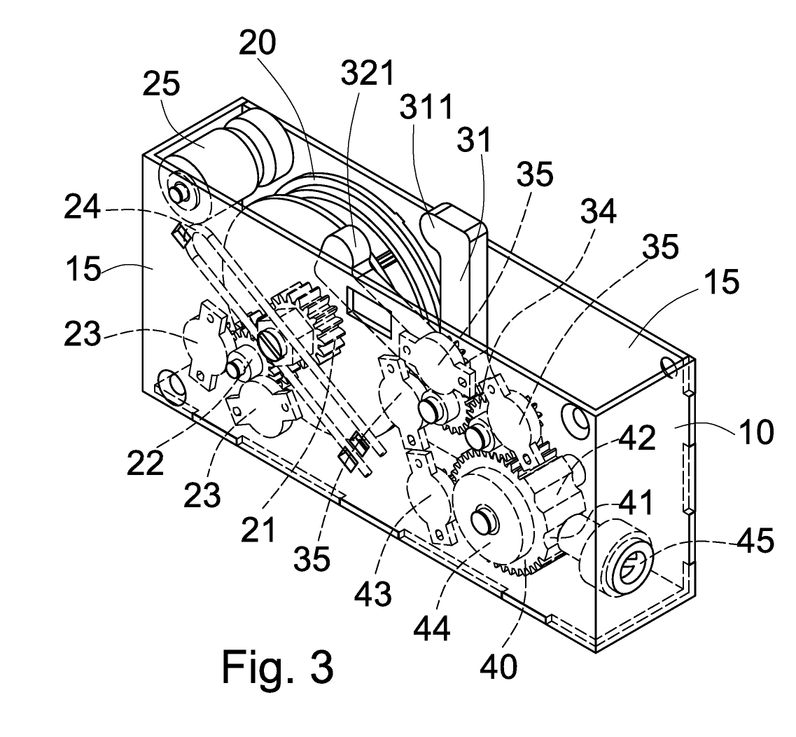

The screw wheel 20 is erectly housed in the accommodation space between the base 10 and the fence 15. The screw wheel 20 contains a coil spring (not shown) capable of producing a restoring resilient force when recoiling and making the screw wheel 20 to wind back or extend the rope 50. The screw wheel 20 is provided with an elastic limit member 24 for limiting its revolution and an adjustable mechanism 26 to adjust resilience of the coil spring. The forward rotation of the adjustable mechanism 26 coils up the coil spring and strengthen its resilient force, and vice versa. A driving gear wheel 21 is attached to the shaft of the screw wheel 20 and mated with a gear unit 22 (see FIG. 3). The driving gear wheel 21, the gear unit 22, or the driving gear wheel 21 along with the gear unit 22 can be coupled with a damper 23, either a viscous damper or an oil-damping device to enforce the retarding effect of the screw wheel 20 thereby stabilizing the restoring force of the coil spring. As a result, accidental loosening of the rope 50 during winding back or extending out by the rotation of the screw wheel 20 can be avoided. Meanwhile, a guide-rolling wheel 25 is provided on the base 10 above the exterior of the screw wheel 20.

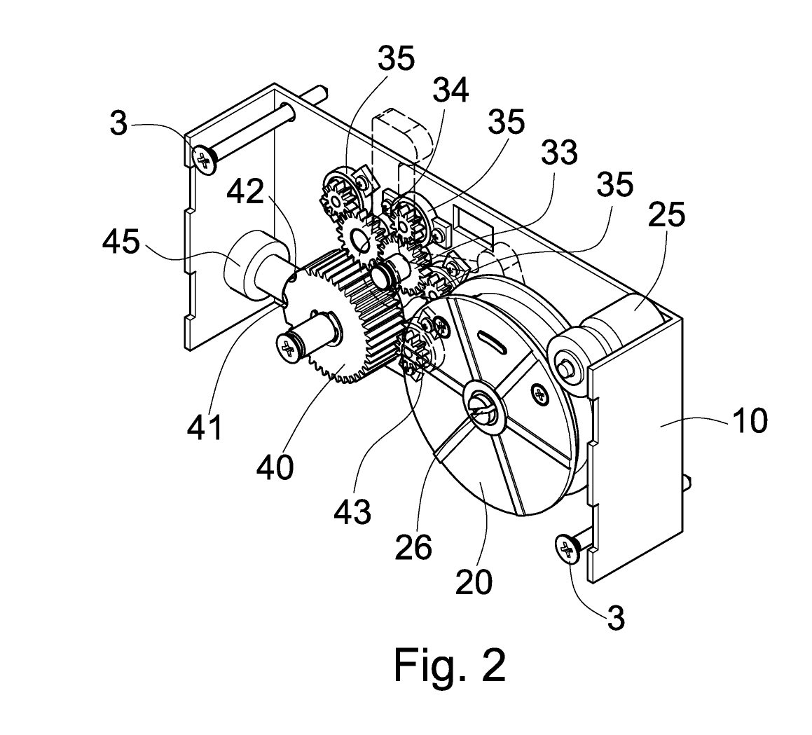

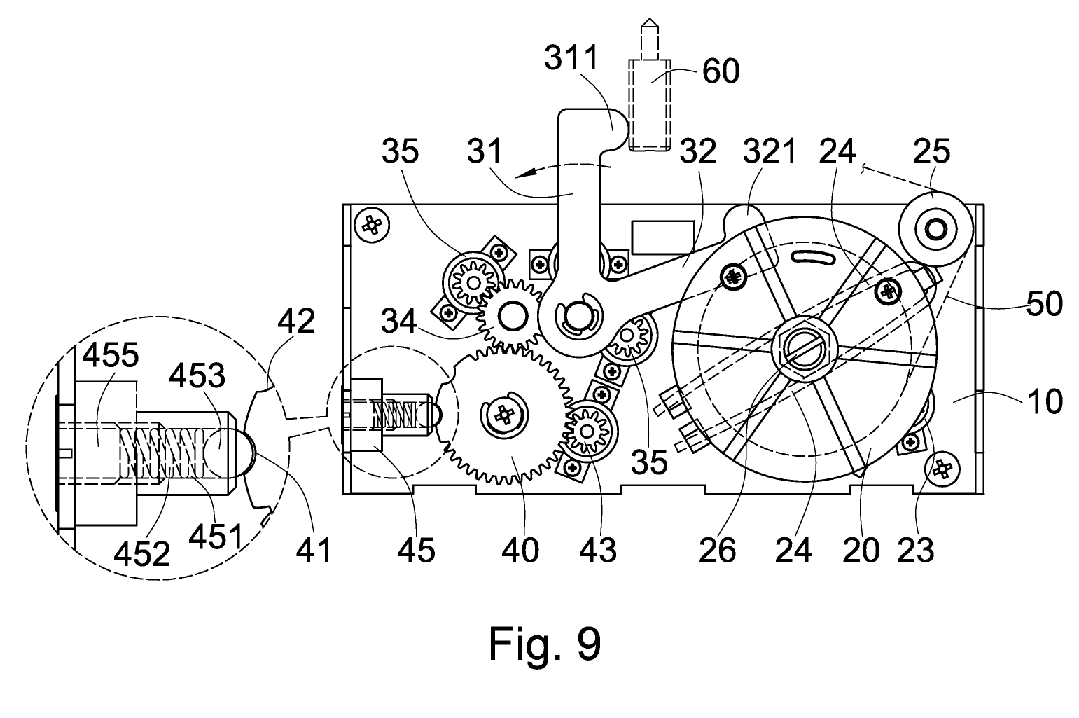

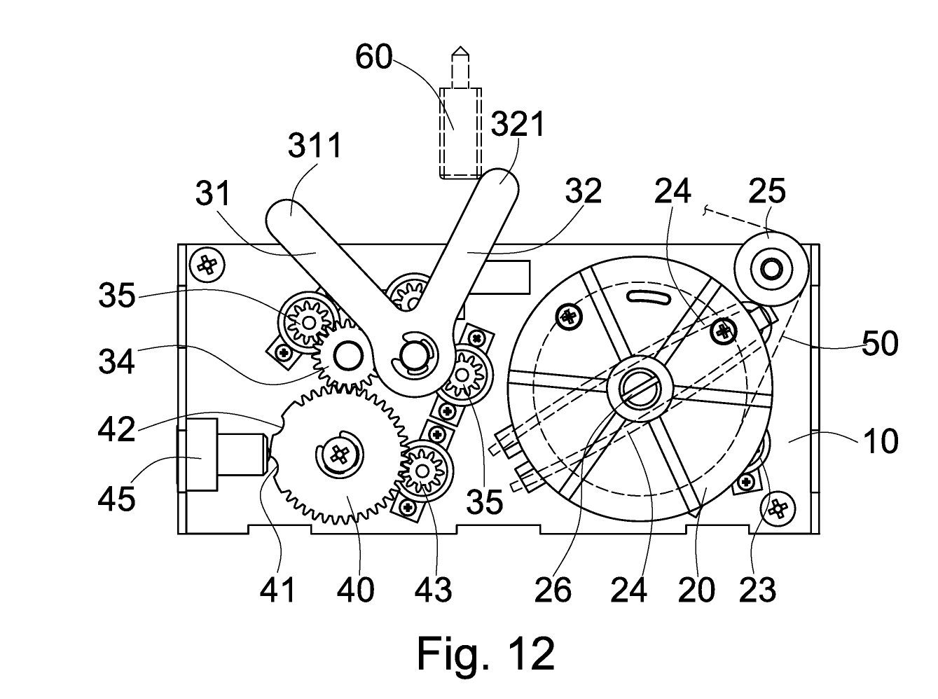

Here, the change over device 30 is erectly housed in the accommodation space between the base 10 and the fence 15 and located in a position at the opposite side of the guide rolling wheel 25 of the screw wheel 20. The change over device 30 has a first and a second rocking bars 31 and 32 extended radially outward with and angle formed therebetween (see FIG. 9 through FIG. 11). The size of aforesaid angle is designed according to a predetermined retarding rotational distance of the screw wheel 20. On the inner side ends of the two rocking bars 30, 31 there are formed arcuate protuberances 311, and 321 respectively to perform change over operation. A driving gear 33 is engaged with the shaft of the change over device 30 (see FIG. 2 and FIG. 3) to actuate simultaneously at least one combined conversion gear 34 to simultaneously actuate the brake gear 40. The driving gear 33 is directly in mesh with the brake gear 40 to drive the brake gear 40. As show in FIG. 12, the arcuate protuberances 311, 321 may be configurated into a desired shape according to the actual needs.

Meanwhile, the size of a door panel 2 must allow at least one damper 35 installed around the vicinity of those component parts of the change over device 30, e.g. the driving gear 33, conversion gear 34, or the paired driving gear 33 and conversion gear 34 to conjoin with so as to provide the retarding effect for the change over device 30.

In an embodiment of the present invention, the brake gear 40 is in mesh with the conversion gear 34, but it is not limited only as such. As shown in FIG. 3, the brake gear 40 is equipped with a damping element 44 to serve braking and retarding effect for the screw wheel 30 to liberate the rope 50. The brake gear 40 is able to be in mesh with at least one nearby damper 43 to provide retarding effect for itself.

The brake gear 40 has at least two positioning dents formed along its own edge at a position opposite to the screw wheel 20. In this embodiment two dents, a first and a second dents 41 and 42 are formed, and a corresponding ball button 45 is provided on the side fence surface of the base 10. There is a cavity 451 with a spring 452 and a rolling element 453 formed inside of the ball button 45. At the side of the ball button 45 is an adjuster 455 to adjust the resilience of the spring 452 to provide the rolling element 453 with an adjustable pre-pressure thereby bringing the rolling element 453 to be trapped into the first or the second dents 41, or 42 and positioned thereat.

With this scheme, a damped closing mechanism for automatic shutting pull door can be operated to retard the travelling speed of the door panel when shutting through the use of the change over device 30.

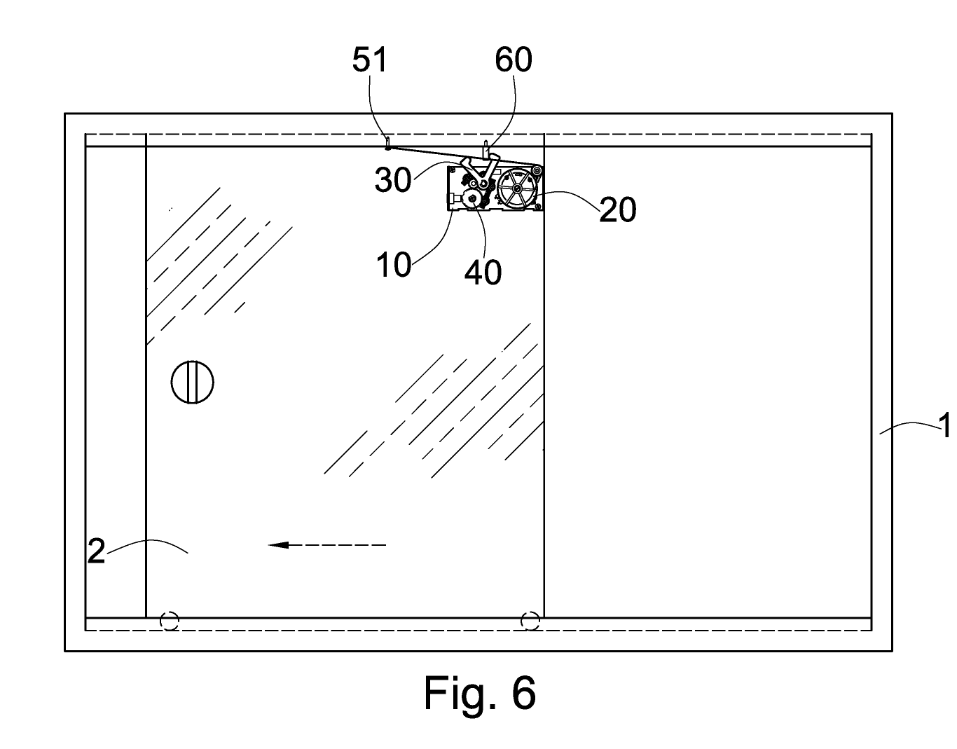

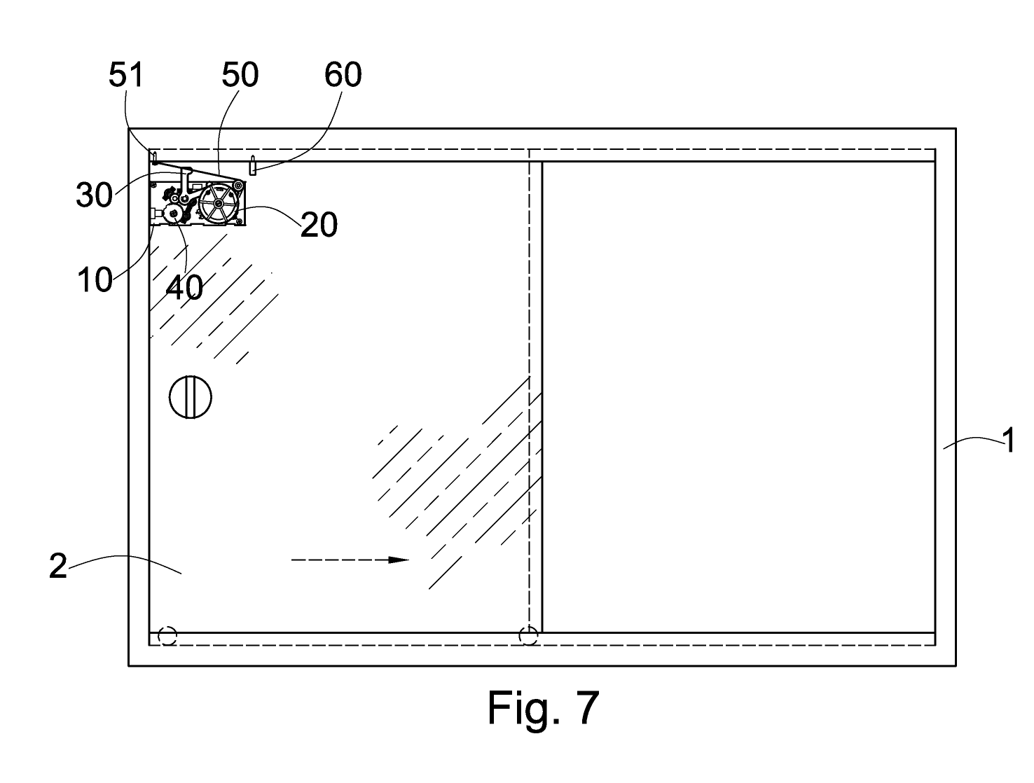

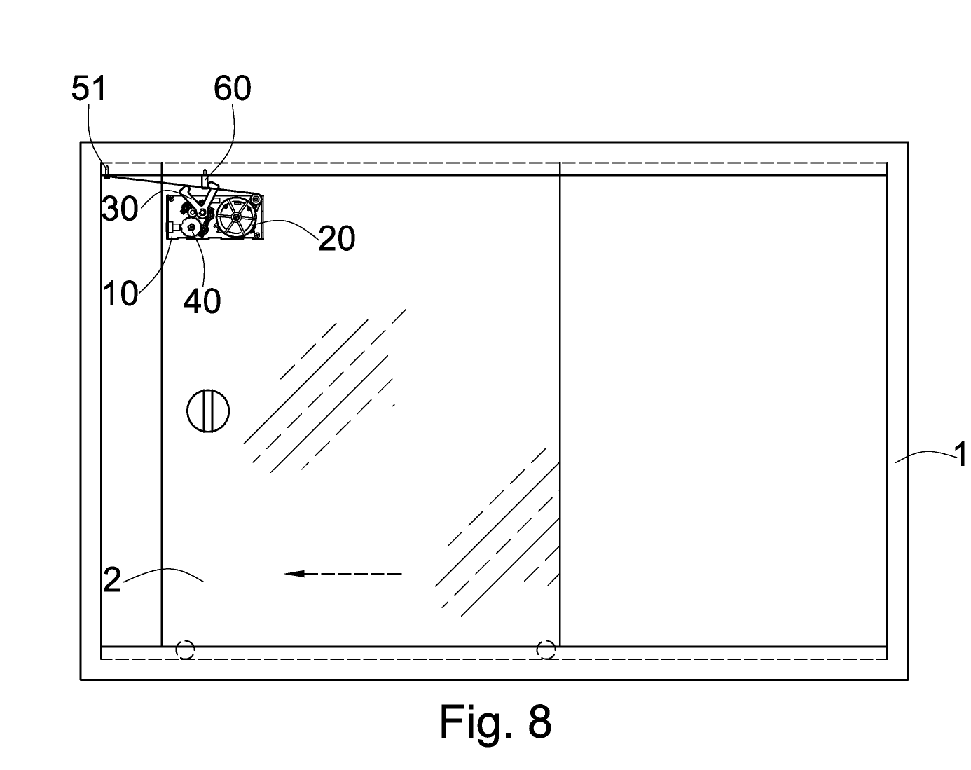

In practical application, reference can be made to FIG. 4 though FIG. 6, or FIG. 7 through FIG. 8, the damped closing mechanism is bolted to the door panel 2, or a door frame 1 with screw 3, it is preferable to install the mechanism on the door panel 2 as near as possible to the door frame 1. In the embodiments of the present invention the closing mechanism is essentially bolted to the door panel 2. The exposed end of the rope 50 which being coiled in the screw wheel 20 is fastened to an appropriate position on the door frame 1 with a fixing member 51. There is a brake member 60 attached to the door frame 1 or panel 2 near the shut position where a fixing member 51 to fix the exposed end of the rope 50 is fastened. The brake member 60 actuates the change over member 30 before shutting the door panel 2.

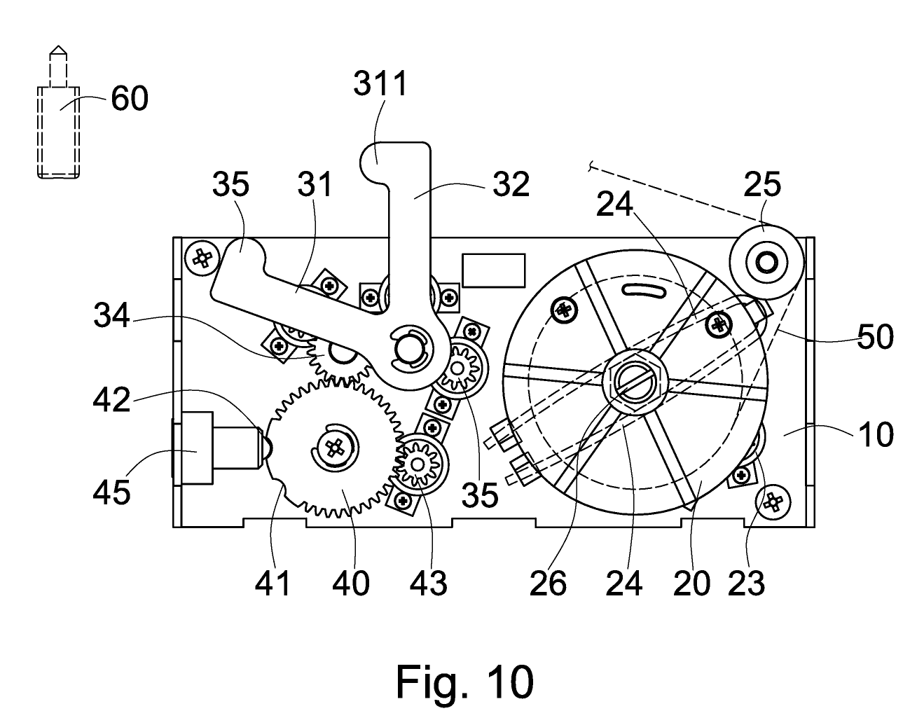

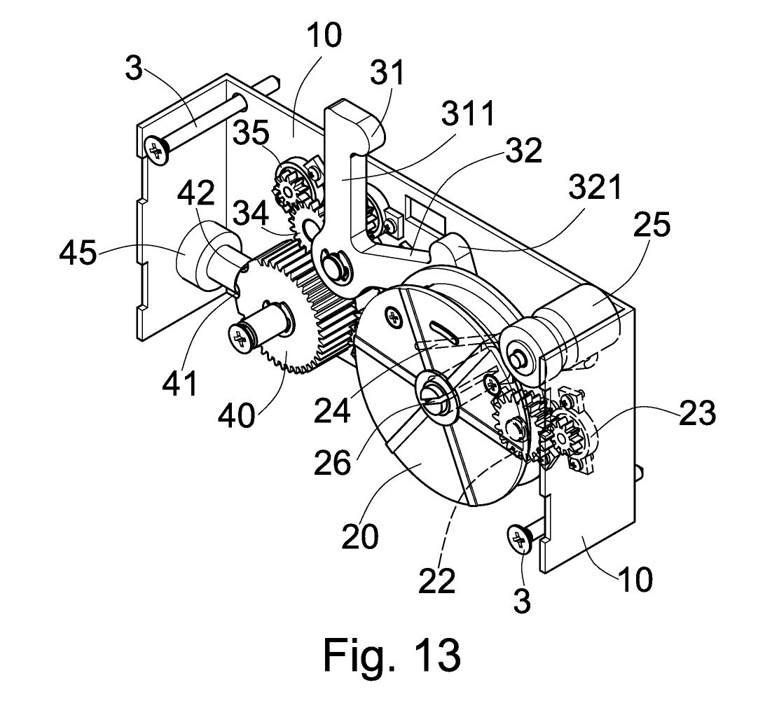

By so, when the door panel 2 is pushed in the opening direction, the rope 50 will be extended by the guide rolling wheel 25, the screw wheel 20 rotates to coil up the coil spring to store the resilient force towards the shutting direction. At the time the door panel 2 goes apart from its shut position, the brake member 60 will actuate the first rocking bar 31 of the change over device 30 on time (see FIG. 9 and FIG. 13) so as to drive the brake gear 40 to rotate thereby causing the ball button 45 to trap into the first dents 41 of the brake gear 40 and positioned there (see FIG. 10). As a result, the damping force of the brake gear 40 is varied causing the door panel 2 easy to be opened.

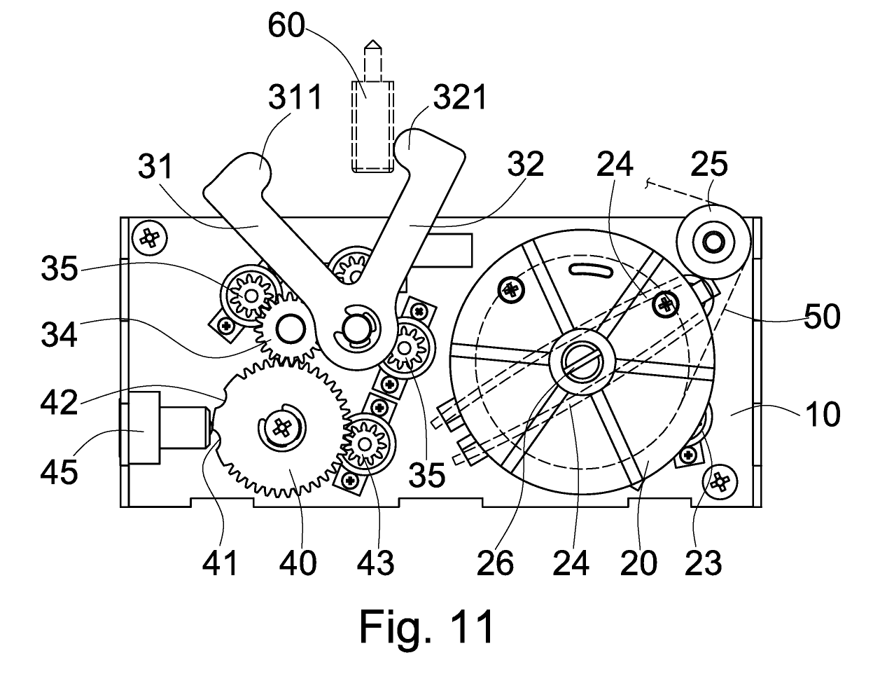

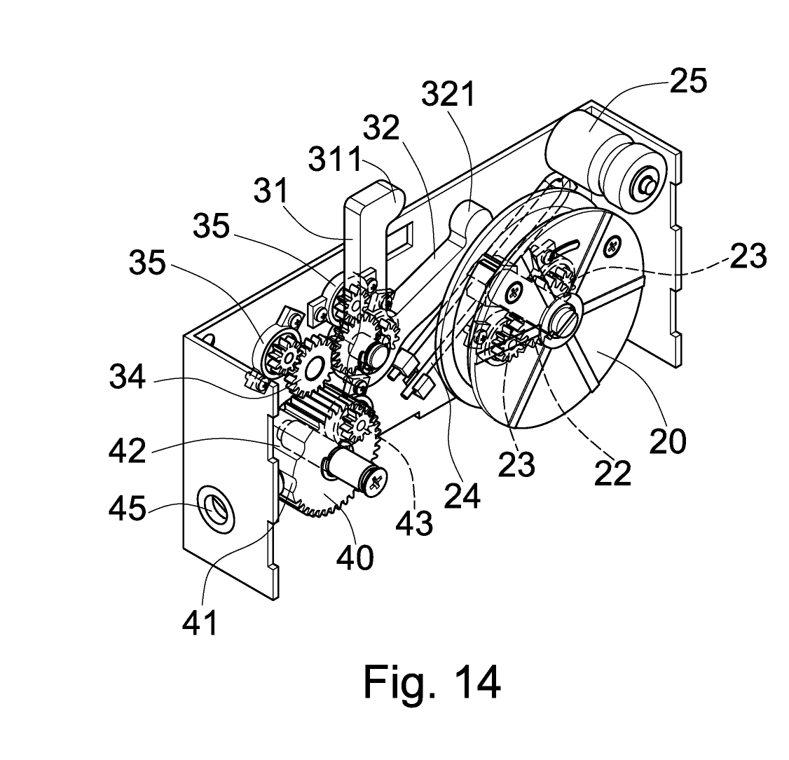

On the contrary, when the door panel 2 is liberated, screw wheel 20 will use its restored resilient force to wind up the rope 50 thereby urging the door panel 2 to move towards closing direction. The screw wheel 20 themselves contains a damper 23 to avoid sudden movement of the door panel 2. The travelling speed of the door panel 2 in closing direction is greater than the winding up speed of the rope 50 by the screw wheel 20. When the second rocking bar 32 of the change over device 30 is in touch with the brake member 60 (see FIG. 11. Through FIG. 14), the brake gear 40 will be driven by the change over device 30 to counteract instantaneously the moving force of the door panel 2 by the cooperated action of the brake gear 40 and the ball button 45, and at the same time, the rolling element 453 of the ball button 45 removes from the first dent 41 to the second dent 42, at this moment the screw wheel 20 has already wound back the rope 50. Then again the change over device 30 actuates the brake gear 40 and at least one damper 43 simultaneously to rotate so as to enhance the damping effect of the brake wheel 40 thereby making the door panel 2 to move under the cooperated damping effect of the screw wheel 20 and the brake gear 40 and the screw wheel 20 uses its remaining restored resilient force to wind back the rope 50.

In the present invention, the cooperated function of the ball button 45 and the second dent 42 of the brake gear 40 further serves to alleviate the restoring resilient force of the coil spring in the screw wheel 20 and retards the moving speed of the door panel 2 towards closing direction so as to restrain bumping impulse and the noise when door is shut but without delaying the returning time of the door to the shut position too long.

It is apparent to a person skilled in the art that the basic idea of the invention can be implemented in many different ways. The invention and its embodiments are thus not restricted to the examples described above, but may vary with the scope of the following claims.

What is claimed is:

1. A damped closing mechanism for automatic shutting pull door essentially comprising:
a base;
a screw wheel erected on said base, capable of producing a restoring resilient force to rewind or extend a rope;
a change over device erected on said base and having a first and a second rocking bars extended radially outward with an angle formed therebetween whose size is designed according to a predetermined retarding rotational distance of said screw wheel; wherein a brake member is attached to the door frame or door panel near the shut position where a fixing member to fix the exposed end of aid rope is fastened, and said brake member is to stir up said first and second rocking bars; and
a brake gear erected on said base, to be actuated by a conversion gear; wherein said brake gear contains a damping clement to serve a damping effect, and also has a first and a second positioning dents in correspondence with said first and second rocking bars of said change over device, and a ball button is provided on the side fence surface of said base for said change over device to vary damping force of said brake gear.

2. The damped closing mechanism of claim 1, wherein said base is a [symbol] shaped frame member having a fence to encircle around the bottom and side openings of said base such that an upwardly opened accommodation space is formed between said base and said fence.

3. The damped closing mechanism of claim 1, wherein said screw wheel contains at least a coil spring capable of producing a restoring resilient force for said screw wheel.

4. The damped closing mechanism of claim 1, wherein a driving gear wheel is attached to the shaft of said screw wheel and is mated with at least a gear unit so as to stabilize the restoring resilient force produced by said coil spring when said screw wheel rotates, and avoid loosening of said rope during winding back or extending out by the rotation of said screw wheel.

5. The damped closing mechanism of claim 1, wherein a driving gear wheel is attached to the shaft of said screw wheel and is mated with at least a damper so as to stabilize the restoring resilient force produced by said coil spring when said screw wheel rotates, and avoid loosening of said rope during winding back or extending out by the rotation of said screw wheel.

6. The damped closing mechanism of claim 1, wherein said rope is wound back when shutting said door panel, and being stretched out when said door panel is removed from shut to open position.

7. The damped closing mechanism of claim 1, wherein on the inner side ends of said first and second rocking bars of said change over device, there are formed corresponding two arcuate protuberances respectively to help perform change over operation.

8. The damped closing mechanism of claim 1, wherein a driving gear is engaged with the shaft of said change over device to actuate simultaneously a combined conversion gear which further actuates simultaneously said brake gear.

9. The damped closing mechanism of claim 1, wherein a driving gear is engaged with the shaft of said change over device to actuate simultaneously a mated damper which further actuates simultaneously said brake gear.

10. The damped closing mechanism of claim 1, wherein said brake gear is able to be in mesh with at least a damper around the vicinity so as to enforce the retarding effect of said brake gear.

11. The damped closing mechanism of claim 1, wherein the exposed end of said rope is fastened to the door panel or door frame at a position where said damped closing mechanism is not installed.
